(19) United States
(12) Patent Application Publication
(10) Pub. No.: US 2004/0215705 A1
(43) Pub. Date: Oct. 28, 2004

(54) Multiprocessor system and device sharing method

(75) Inventor: Takeo Hosomi, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/776,307

(22) Filed: Feb. 12, 2004

(30) Foreign Application Priority Data
Feb. 17, 2003 (JP) 2003-38201

(51) Int. Cl. G06F 15/16

(52) U.S. Cl. 709/201

(57) ABSTRACT

A device sharing method is disclosed for sharing devices in a multiprocessor system having a plurality of CPU cells that are each provided with at least one CPU, the CPU cells being divided into a plurality of groups and each group operating under a different operating system. Device cells that include devices that are connected to CPU cells by way of a network are provided with device control information for controlling processing of a plurality of types that can be executed by the devices. When a command is received from a CPU cell in a device cell, the device control information that corresponds to the originator of the command is searched, and a device is caused to execute processing that is designated by device control information that is updated by the command.

### BACKGROUND OF THE INVENTION

1. Field of the Invention

The present invention relates to a multiprocessor system that includes a plurality of CPUs, and more particularly to a multiprocessor system and a device sharing method for sharing devices by each the operating systems in an environment that operates under a plurality of operating systems.

2. Description of the Related Art

First Example of the Prior Art

FIG. 1 is a block diagram showing the configuration of a first example of a multiprocessor of the prior art, this figure being the configuration that is disclosed in Japanese Patent Laid-Open Publication No. 229967/2002 (first patent document).

As shown in FIG. 1, the multiprocessor system of the first example of the prior art is a construction that includes a plurality of CPU cells 200 and a plurality of device cells 206, this plurality of cells being connected by way of network 205.

CPU cells 200 are each provided with a plurality of CPUs 201, control circuit 202 for controlling the operation of CPUs 201, memory 203 for storing programs and data, and communication circuit (CC) 204 for controlling communication with network 205.

Device cells 206 are each provided with a plurality of devices 209 such as external storage devices and input/output devices that are used in the processing of each CPU cell 200; IO control circuit 208, which is the interface to devices 209; and communication circuit (CC) 207 for controlling communication with network 205. CPU cells 200 and device cells 206 use communication circuits 204 and 207 that are provided to transmit and receive packets that contain commands and data by way of network 205. Moreover, because a plurality of each of CPU cells 200 and device cells 206 are provided in FIG. 1 (two of each in FIG. 1), each CPU cell is distinguished by conferring reference numbers such as 200-1 and 200-2 and each device cell is distinguished by conferring reference numbers such as 206-1 and 206-2. Further, the plurality of CPUs in the CPU cells (two in the FIG. 1) are distinguished by conferring reference numbers such as 201-11 and 201-12; and the control circuits, memories, and communication circuits are conferred reference numbers that correspond to the reference number that has been conferred to the CPU cells, such as control circuit 202-1, memory 203-1, and communication circuit 204-1. In addition, the plurality of devices (two in FIG. 1) inside the device cells are distinguished by conferring numerals such as 209-11 and 209-12; and the IO control circuits and communication circuits are conferred numerals that correspond to the numerals conferred to the device cells, such as IO control circuit 208-1 and communication circuit 207-1.

At the time of start-up in a multiprocessor system of this type, the destination information of device cell 206 that is used in one CPU cell 200 is set to communication circuit 204 of that CPU cell 200, and the destination information of CPU 200 that uses that device cell 206 is set to communication circuit 207 of device cell 206.

Next, when a command is issued from CPU 201 upon the start of operation of the system, the command is transferred to communication circuit 204, and the command is transmitted from communication circuit 204 by way of network 205 to the appropriate device cell 206 in accordance with the destination information that was set at the time of system start-up.

In device cell 206, the command transmitted from CPU cell 200 is received by communication circuit 207, and device 209 inside that cell is controlled based on the content of the command. The response message for that command is then transmitted from communication circuit 207 by way of network 205 to appropriate CPU cell 200 in accordance with the destination information that was set at the time of system start-up. In CPU cell 200, the transmitted response message is received by communication circuit 204 and transferred to CPU 201.

Second Example of the Prior Art

The multiprocessor system of the second example of the prior art is a technique for using the configuration that is shown in FIG. 1 to share memory that is provided in a plurality of CPU cells. This technique is disclosed in, for example, Japanese Patent Laid-Open Publication No. 259596/2000 (second patent document).

In the multiprocessor system of the second example of the prior art, when an access command is issued from CPU 201-11 of CPU cell 200-1 to memory 203-2 of CPU cell 200-2, the access command is transmitted by communication circuit 204-1 to CPU cell 200-2 by way of network 205.

CPU cell 200-2, upon receiving the access command to memory 203-2 at communication circuit 204-2, accesses memory 203-2 in accordance with the access command. CPU cell 200-2 then transmits the response message for this access command from communication circuit 204-2 by way of network 205 to CPU cell 200-1. CPU cell 200-1 receives the response message that was transmitted from CPU cell 200-2 at communication circuit 204-1 and transfers the message to CPU 201-11.

Applying this type of technique in the construction of the first example of the prior art enables CPU cell 200-2 to access even device cell 206-1 that is assigned to CPU cell 200-1.

For example, when an input/output instruction is issued from CPU 201-21 of CPU cell 200-2, this input/output instruction is delivered to communication circuit 204-2 and then transmitted from communication circuit 204-2 by way of network 205 to CPU cell 200-1.

CPU cell 200-1, upon receiving the input/output instruction that has been transmitted from CPU cell 200-2 at communication circuit 204-1, employs communication circuit 204-1 to transmit the input/output instruction by way of network 205 to the appropriate device cell 206-1 in accordance with the destination information that was set at the time of system start-up.

Device cell 206-1 receives the command that was transmitted from CPU cell 200-1 at communication circuit 207-1 and controls device 209 inside that cell based on the content of the command. Device cell 206-1 then transmits a response message for that command in accordance with the destination information that was set at the time of system start-up from communication circuit 207-1 by way of network 205 to the appropriate CPU cell 200-1. CPU cell 200-1 receives the transmitted response message at communication circuit 204-1 and delivers the response message to CPU cell 200-2 by way of network 205. CPU cell 200-2 receives the response message by communication circuit 204-2 and transfers the response message to CPU 201-21.

Third Example of the Prior Art

The multiprocessor system of the third example of the prior art is a method for sharing storage devices (a storage device such as a hard disk device or an optical disk device) among CPU cells that operate under different operating systems (OS) and is a technique that has been disclosed in, for example, Manual of Fiber Channel Technology, edited by the Fiber Channel Conference and published by Ronsou Company; and in Japanese Patent Laid-Open Publication No. 347815/2000 (third patent document).

FIG. 2 is a block diagram showing the construction of the multiprocessor system of the third example of the prior art.

As shown in FIG. 2, the multiprocessor system of the third example of the prior art includes storage cell 212 that is provided with a plurality of storage devices in addition to the multiprocessor system of the first example of the prior art that was shown in FIG. 1, and is a construction in which storage cell 212 is connected to a plurality of device cells 206 by fiber channel (hereinbelow abbreviated as “FC”) network 211.

Device cells 206 are provided with FC devices 210 for communicating by way of FC network 211.

In addition, storage cell 212 is provided with: a plurality of storage devices 215 for storing data; storage control bridge 214 for controlling the operation of storage devices 215; and host input/output means 213 for controlling communication with device cells 206 by way of FC network 211. In FIG. 2, as with the multiprocessor system that is shown in FIG. 1, each CPU cell is distinguished by conferring numerals such as 200-1 and 200-2, and each device cell is distinguished by conferring numerals such as 206-1 and 206-2. Further, the plurality of CPUs (two in FIG. 2) in each CPU cell are distinguished by conferring numerals such as 201-11 and 201-12, and the control circuits, memories, and communication circuits are each conferred numerals according to the numerals that are conferred to the CPU cells, such as control circuit 202-1, memory 203-1, and communication circuit 204-1. In addition, the devices, FC devices, I/O control circuits, and communication circuits in each device cell are conferred numerals according to the numeral conferred to the device cell, such as device 209-1, FC device 210-1, I/O control circuit 208-1, and communication circuit 207-1. Finally, the plurality of storage devices (two in FIG. 2) in storage cell 212 are distinguished by conferring numerals such as 215-1 and 215-2.

When accessing storage cell 212 from each CPU cell 200 in a multiprocessor system of this type, storage cell 212 can be accessed by way of FC device 210 inside the corresponding device cell 206. Accordingly, storage cell 212 can be shared by a plurality of CPU cells 200 that operate under different operating systems.

Of the above-described multiprocessor systems of the prior art, the multiprocessor system of the first example of the prior art has the drawback that a device cell can be accessed only from a CPU cell that was assigned at the time of system start-up.

For example, in order for CPU cell 200-2 to use device 209-11 that has been assigned to CPU cell 200-1 in the multiprocessor system that is shown in FIG. 1, the operations of CPU cell 200-1 and CPU cell 200-2 must first be halted, the destination information that is set in each communication circuits of CPU cell 200-1, CPU cell 200-2, and device cell 206-1 must be altered, and CPU cell 200-1 and CPU cell 200-2 must then be reactivated.

This necessity to shut down the system to switch access to device cells 206 in this way reduces the performance and availability of the multiprocessor system.

In the multiprocessor system of the second example of the prior art, accessing a device cell that was not assigned at the time of system start-up requires that a command be transmitted through the network two times, thus increasing the latency of input/output instructions and degrading system performance. In addition, before a next input/output instruction is issued in the CPU cell, it must be confirmed that the previously issued input/output instruction has arrived at the CPU cell that was assigned to the device cell that is the destination. The latency of the time for a command to complete a round trip in the network becomes the turnaround time and degrades the processing performance for input/output instructions.

Further, a combination of the first example of the prior art and second example of the prior art enables the use of a single device by a plurality of CPU cells, but this possibility presupposes that all CPU cells are operating under a single OS.

The multiprocessor system of the third example of the prior art necessitates an FC network for sharing storage devices in addition to the network that provides the communication function between CPU cells and device cells and therefore has the drawback of increased hardware costs. In addition, access of a storage device from a CPU cell transits an FC device, and a device driver for the FC devices must therefore be developed in addition to the device drivers for storage devices.

The multiprocessor system of the third example of the prior art enables an improvement in reliability through the management of a plurality of FC devices by a single device driver and an improvement of performance through distribution of load. Nevertheless, in a case in which, for example, a single multiprocessor system is partitioned and operates under four operating systems, two FC devices are required for each operating system to guarantee reliability, and this multiprocessor system therefore has the drawback of increased hardware costs in the case of partitioning.

In addition, the third patent document does not disclose a method or technique for optimizing the selection of the plurality of FC devices to improve the turnaround time and the latency of input/output instructions to the FC devices for cases in which a plurality of FC devices is managed by a single device driver.

Finally, there is the drawback that device drivers normally implement exclusive control such that competition for access to a controlling FC device does not occur, and consequently, for example, when two application programs simultaneously issue requests to access the same FC device, the exclusive control blocks the access request of one application program and causes a drop in performance.

### SUMMARY OF THE INVENTION

The present invention was realized for solving the above-described problems of the prior art and has as its first object the provision of a multiprocessor system having a simple architecture that allows sharing of devices even in an environment that operates under a plurality of operating systems.

It is a second object of the present invention to provide a multiprocessor system that not only shortens the latency or turnaround time of input/output instructions to devices, but that also reduces competition of access requests to devices, prevents increase in the volume of traffic of a network, and improves access to devices.

It is a third object of the present invention to provide a multiprocessor system that, without increasing hardware costs, can improve the reliability of devices and performance through load distribution.

To achieve the above object, in the present invention, device cells are provided with device control information for controlling a plurality of types of processing that can be executed in devices, and when a command is received from a CPU cell, device control information that corresponds to the originator of the command is searched and a device is caused to execute processing that is designated by the device control information that has been updated by the command. Accordingly, the same device can be accessed by each CPU cell or each group, device sharing can be realized by means of simple hardware, and hardware cost can be reduced.

In addition, the number of devices required for improving the reliability of devices and for distributing load is fixed regardless of the number of operating systems that function in the multiprocessor system, whereby the cost of hardware can be reduced.

In addition, CPU cells hold information in table format regarding devices that the CPU cells can use, and devices that are assigned to the CPU cells at the time of system start-up are used preferentially, whereby, for example, the latency of input/output instructions to a device becomes the time for one round-trip of the network. Further, the turnaround time is a time that is confined within the CPU cells and thus can be made shorter than the time for accessing a device that entails one round trip of the network. As a result, when a plurality of similar devices is assigned to a single operating system, the turnaround time and latency of an input/output instruction to a device can be shortened.

Still further, device cells are provided with a plurality of similar devices, and any device among the plurality of devices can be caused to execute processing that is designated by device control information, whereby, for example, other devices can be used to continue processing if a problem should occur during the use of any device. In this way, “fail-over” can be realized when a problem occurs. In addition, processing can be distributed among a plurality of devices.

Still further, CPU cells are equipped with command transmission circuits for generating commands in which are combined a plurality of instructions that are issued from CPUs; device cells are provided with command analysis units for analyzing commands and extracting a plurality of instructions; and causing devices to execute processing that is designated by device control information that has been updated by the plurality of extracted instructions enables a decrease in the traffic on a network that results from, for example, input/output instructions to devices, and further, enables an improvement in access to devices.

Still further, CPU cells hold system identifiers for specifying the groups to which the CPU cells belong, device cells hold system configuration information that is constituted from lists of CPU cells that correspond to the system identifiers, device cells select any one CPU cell from among the groups to which the CPU cells belong based on the system configuration information that is held and the system identifiers that have been sent from the CPU cells together with commands and transmit response message that contain the processing results relating to commands to the selected CPU cell, and the CPU cells, upon receiving response messages from the device cells, acquire the processing results of the device cells in accordance with the response messages; whereby device cells can correctly return response messages to the groups that issued commands even in the event of an alteration of the system configuration during processing of the commands.

In addition, the present invention enables distribution of the load of CPU cells and the network that connects CPU cells and device cells.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing the configuration of the multiprocessor system of the first example of the prior art;

FIG. 2 is a block diagram showing the configuration of the multiprocessor system of the third example of the prior art;

FIG. 3 is a block diagram showing the configuration of the first embodiment of the multiprocessor system of the present invention;

FIG. 4 is a schematic view showing the composition of a packet that is transmitted over the network shown in FIG. 3;

FIG. 5 is a block diagram showing the port configuration of the device shown in FIG. 3;

FIG. 6 is a block diagram showing the composition of device control information that is provided in the device control bridge shown in FIG. 3;

FIG. 7 is a block diagram showing the composition of device control information in the multiprocessor system of the second embodiment of the present invention;

FIG. 8 is a flow chart showing the procedures of the third embodiment of the multiprocessor system of the present invention;

FIG. 9 is a table showing information that is held by the device driver that is provided in each system of the multiprocessor system of the third embodiment;

FIG. 10 is a block diagram showing the configuration of a device cell in the multiprocessor system of the fourth embodiment;

FIG. 11 is a block diagram showing the configuration of a modification of the device cell in the multiprocessor system of the fourth embodiment;

FIG. 12 is a table showing the information that is held by the device control unit shown in FIG. 11;

FIG. 13 is a flow chart showing the procedures of the fourth embodiment of the multiprocessor system of the present invention;

FIG. 14 is a block diagram showing the configuration of the fifth embodiment of the multiprocessor system of the present invention; and

FIG. 15 is a block diagram showing the composition of device control information that is provided in the device control bridge shown in FIG. 14.

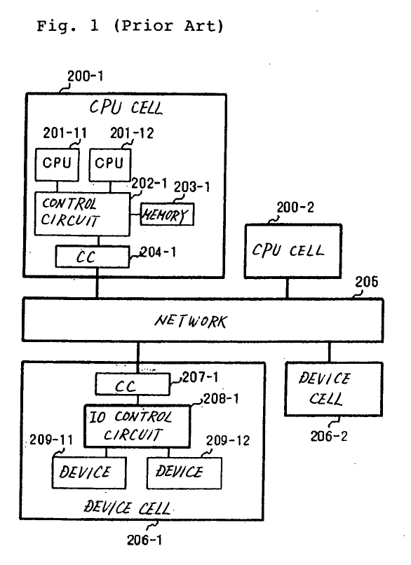

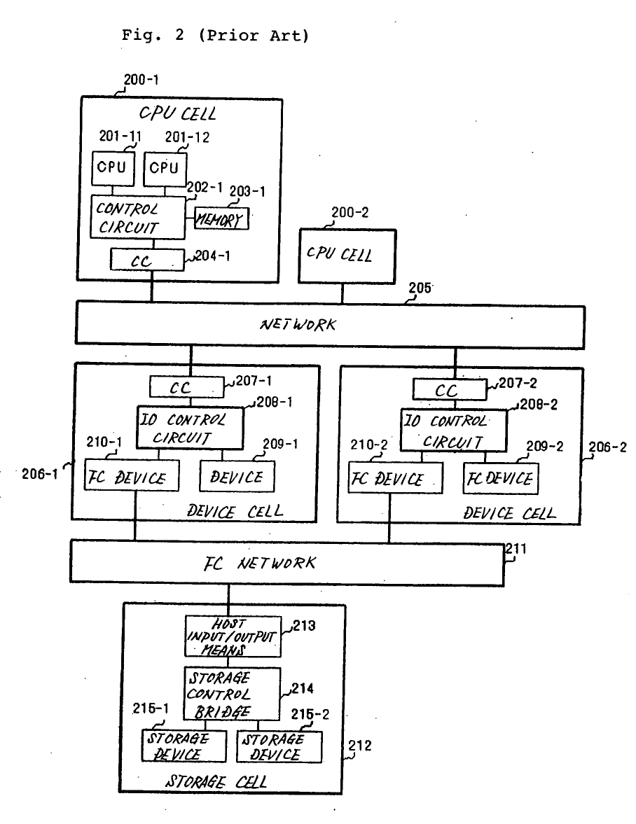

### DETAILED DESCRIPTION OF THE PREFERRED EMBODIMENTS

The present invention is next described with reference to the accompanying drawings.

First Embodiment

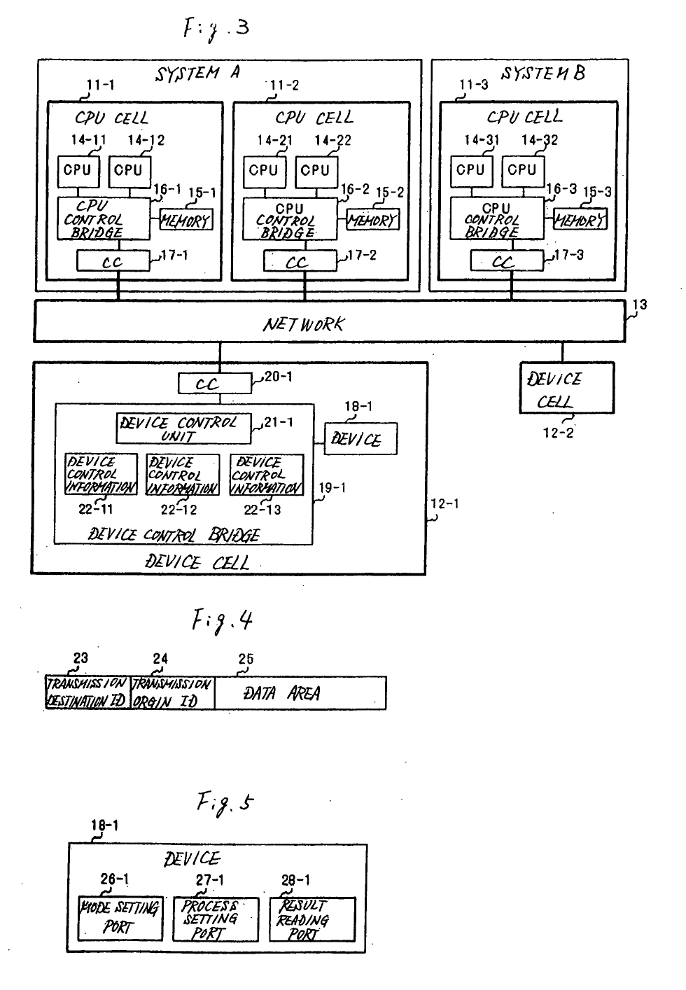

FIG. 3 is a block diagram showing the configuration of the first embodiment of the multiprocessor system of the present invention, and FIG. 4 is a schematic view showing the composition of packets that are transmitted over the network that is shown in FIG. 3. In addition, FIG. 5 is a block diagram showing the port configuration of the device shown in FIG. 3, and FIG. 6 is a block diagram showing the composition of device control information that is provided in the device control bridge shown in FIG. 3.

As shown in FIG. 3, the multiprocessor system of the first embodiment is a construction that includes a plurality of CPU cells 11 and a plurality of device cells 12, these CPU cells 11 and device cells 12 being connected by way of network 13.

CPU cells 11 are each provided with: a plurality of CPUs 14, CPU control bridge 16 for controlling the operation of CPUs 14, memory 15 for storing programs and data, and communication circuit (CC) 17 for controlling communication with network 13.

CPUs 14 execute prescribed processing by executing application programs under the control of the operating system that is stored in memory 15. At such times, commands such as input/output instructions and memory access instructions are supplied as output to CPU control bridges 16. When a command that is issued from CPUs 14 is an input/output instruction, the command designates the port of the device (input device or output device) that is the object, and when the command is a memory access instruction, the command designates the address of the memory that is to be accessed.

Device cells 12 are provided with: devices 18; device control bridges 19, which are interfaces to the devices; and communication circuits (CC) 20 for controlling communication with network 13.

Device control bridges 19 are each provided with: device control unit 21; and a plurality of sets of device control information 22, which are storage areas that are prepared for each CPU cell 11. Device control information 22 is for holding the state of devices that can be seen (that can be accessed) from the corresponding CPU cell 11.

CPU cells 11 and device cells 12 use the communication circuits that are respectively provided to transmit and receive packets that contain commands and data by way of network 13.

Communication circuits that are provided in CPU cells 11 and device cells 12 are each conferred a unique ID for distinguishing the communication circuit (these ID also being the identification that specifies CPU cells 11 and device cells 12). In addition, CPUs 14 are each conferred a unique CPU ID for distinguishing CPUs 14.

As shown in FIG. 4, information that contains the CPU ID is stored in data area 25 together with the input/output instructions or memory access instructions that are issued from CPU 14 in packets. In addition, the ID of the communication circuit that is provided in CPU cell 11 or device cell 12 that is the transmission destination is stored in transmission destination ID 23; and the ID of the communication circuit that is provided in the CPU cell 11 or device cell 12 that is the transmission origin is stored in transmission origin ID 24. Network 13 refers to the transmission destination ID 23 and the transmission origin ID 24 in packets and delivers the packets from the communication circuit of the transmission origin to the communication circuit that is specified by the transmission destination ID.

FIG. 3 shows an example of the configuration of a multiprocessor system that has three CPU cells 11 and two device cells 12, the CPU cells each being distinguished by conferring numerals such as 11-1, 11-2, and 11-3; and the device cells each being distinguished by conferring numerals such as 12-1 and 12-2. In addition, the plurality of CPUs in the CPU cells (two in FIG. 3) are distinguished by conferring numerals such as 14-11 and 14-12; and the CPU control bridges, memories, and communication circuits are each conferred numerals that accord with the numerals conferred to each CPU cell, such as CPU control bridge 16-1, memory 15-1, and communication circuit 17-1. Still further, the devices, device control bridges and communication circuits in the device cells are each conferred numerals that accord with the numerals conferred to each device cell, such as device 18-1, device control bridge 19-1, and communication circuit 20-1.

The multiprocessor system that is shown in FIG. 3 is partitioned at the time of system start-up into system A, which is made up by CPU cell 11-1 and CPU cell 11-2, and system B, which is made up by CPU cell 11-3; system A and system B operating under different operating systems.

Here, as shown in FIG. 5, device 18 is provided with mode-setting port 26 for setting the operating mode, process-setting port 27 for setting the processing, and result-reading port 28 for storing the results of processing. When information is written to process-setting port 27 due to a command from CPU cell 11, device 18 executes processing based on the content that was written to mode-setting port 26 and to process-setting port 27 and writes the processing results to result-reading port 28. In this device 18 are a total of four processes: a first process and a second process that are executed in a first mode, and a first process and a second process that are executed in a second mode.

As shown in FIG. 6, device control information 22 is provided with mode setting register 29 for temporarily holding the operating mode that has been set and result register 30 for temporarily holding processing results. Device control information 22 that includes this mode-setting register 29 and result register 30 is provided to correspond to each CPU cell 11, as shown in FIG. 3. As shown in FIG. 3, the device control information is given a numeral such as device control information 22-13 that corresponds to device 18-1 and CPU cell 11-3, the numerals being conferred to accord with the numerals that have been conferred to device 18 and to the corresponding CPU cell. In addition, as shown in FIG. 6, numerals are conferred to the mode-setting registers and result registers according to the numerals that have been conferred to the device control information, such as mode-setting register 29-11 and result register 30-11.

The operation of the multiprocessor system of the present embodiment is next explained, taking as an example a case in which the two systems, System A and System B, shown in FIG. 3 share a single device 18-1. It is assumed that at the time of system start-up, the address information of device cell 12-1 is written to communication circuit 17-1 of CPU cell 11-1 as the address of the input/output port that corresponds to device 18-1 that is used in System A; the address information of device cell 12-1 is written to communication circuit 17-3 of CPU cell 11-3 as the address of the input/output port that corresponds to device 18-1 that is used in System B; and the address information of CPU cell 11-1 is written to communication circuit 17-2 of CPU cell 11-2 as the address of input/output port that corresponds to device 18-1 that is used in System A.

Further, CPU 14-22 of CPU cell 11-2 that belongs to System A, with respect to device 18-1, writes the first mode to mode-setting port 26-1, writes the first process to process-setting port 27-1, and reads the results from result-reading port 28-1. CPU 14-31 of CPU cell 11-3 that belongs to System B, with respect to device 18-1, writes the second mode to mode-setting port 26-1, writes the second process to process-setting port 27-1, and reads the results from result-reading port 28-1. This explanation relates to a case in which System A and System B simultaneously access device 18-1.

When CPU 14-22 of CPU cell 11-2 issues an input/output instruction for writing the first mode to mode-setting port 26-1 of device 18-1, communication circuit 17-2 transmits packets containing the input/output instruction to CPU cell 11-1 by way of network 13 in accordance with the address information that was set at the time of system start-up. At this time, transmission destination ID 23 of the packets that are sent indicates CPU cell 11-1, transmission origin ID24 indicates CPU cell 11-2, and the input/output instruction that is issued at CPU 14-22 and the CPU ID that indicates CPU 14-22 are stored in data area 25.

CPU cell 11-1, upon receiving at communication circuit 17-1 packets that have been transmitted from CPU cell 11-2, transmits the relevant packets from communication circuit 17-1 by way of network 13 to the appropriate device cell 12-1 in accordance with address information that was set at the time of system start-up. At this time, transmission destination ID 23 of the packets indicates device cell 12-1, transmission origin ID 24 indicates CPU 11-1; and the setting input/output instruction that is issued from CPU 14-22, the CPU ID, and the request origin ID that indicates CPU cell 11-2 are stored in data area 25.

Upon receiving packets that have been transmitted from CPU cell 11-1 at communication circuit 20-1, device cell 12-1 transfers input/output instructions that are extracted from these packets to device control unit 21-1. Device control unit 21-1 refers to device control information 22-11 that corresponds to CPU cell 11-1, which is the packet transmission origin, and based on the content of the received input/output instructions and device control information 22-11, controls device 18-1 or updates device control information 22-11 as necessary. In this case, the input/output instruction is for writing the first mode, and device control unit 21-1 therefore writes the first mode to mode register 29-11 of device control information 22-11 and thus completes processing.

Next, when CPU 14-31 of CPU cell 11-3 issues an input/output instruction for writing the second mode to mode-setting port 26-1 of device 18-1, packets containing the input/output instruction are transmitted by communication circuit 17-3 by way of network 13 to the appropriate device cell 12-1 in accordance with the address information that was set at the time of system start-up. At this time, transmission destination ID 23 of the packets indicates device cell 12-1, transmission origin ID 24 indicates CPU cell 11-3, and the input/output instruction that was issued from CPU 14-31 and the CPU ID are stored in data area 25.

Upon receiving the packets that have been transmitted from CPU cell 11-3 at communication circuit 20-1, device cell 12-1 transfers the input/output instructions that are extracted from the packets to device control unit 21-1. Device control unit 21-1 refers to device control information 22-13 that corresponds to CPU cell 11-3, which is the packet transmission origin, and based on the received input/output instruction and the content of device control information 22-13, controls device 18-1 or updates device control information 22-13 as necessary. In this case, the input/output instruction is for writing the second mode, and device control unit 21-1 therefore writes the second mode to mode register 29-13 of device control information 22-13 and thus completes the process.

Next, when CPU 14-22 of CPU cell 11-2 issues an input/output instruction for writing the first process to process-setting port 27-1 of device 18-1, the input/output instruction is conveyed to device control unit 21-1 of device cell 12-1 by the same procedures used when the input/output instruction for writing the first mode was issued.

Device control unit 21-1 reads mode register 29-11 of device control information 22-11 that corresponds to CPU cell 11-1, which is the packet transmission origin, and writes the content of mode register 29-11 to mode-setting port 26-1 of device 18-1. Device control unit 21-1 then writes the first process to process-setting port 27-1 in accordance with the input/output instruction for writing the first process.

Device 18-1 receives the writing to process-setting port 27-1, executes the first process of the first mode, and writes the processing results to result-reading port 28-1. Device control unit 21-1 monitors result-reading port 28-1, and upon recognizing that processing results have been written, reads the processing results from result-reading port 28-1 and writes the content to result register 30-11.

Next, when CPU 14-31 of CPU cell 11-3 issues an input/output instruction for writing the second process to process-setting port 27-1 of device 18-1, the input/output instruction is conveyed to device control unit 21-1 of device cell 12-1 by the same procedures used when the input/output instruction was issued for writing the second mode.

Device control unit 21-1 reads mode register 29-13 of device control information 22-13 that corresponds to transmission origin CPU cell 11-3, and writes this content (second mode) to mode-setting port 26-1 of device 18-1. Device control unit 21-1 next writes the second process to process-setting port 27-1 in accordance with the input/output instruction for writing the second process.

Device 18-1 receives the writing to process-setting port 27-1, executes the second process of the second mode, and writes the processing results to result-reading port 28-1. Device control unit 21-1 monitors result-reading port 28-1, and upon recognizing that processing results have been written, reads the processing results from result-reading port 28-1 and writes the content of these results to result register 30-13.

Next, when CPU 14-22 of CPU cell 11-2 issues an input/output instruction for reading from result-reading port 28-1 of device 18-1, the input/output instruction is conveyed to device control unit 21-1 of device cell 12-1 by the same procedures used when issuing the input/output instruction for writing the first mode. Device control unit 21-1 reads result register 30-11 of device control information 22-11 that corresponds to CPU cell 11-1, which is the packet transmission origin, and transfers the content to communication circuit 20-1 as a response message. Communication circuit 20-1 transmits packets that contain this response message to CPU cell 11-1, which is the transmission origin. At this time, packet transmission destination ID23 indicates CPU cell 11-1, transmission origin ID 24 indicates device cell 12-1, and the response message, a CPU ID that indicates CPU 14-22, and a request origin ID that indicates the request origin CPU cell 11-2 are stored in data area 25.

Upon receiving packets containing this response message at communication circuit 17-1, CPU cell 11-1 delivers the response message to CPU cell 11-2 by way of network 13. At this time, transmission destination ID 23 of the packets indicates CPU cell 11-2, transmission origin ID 24 indicates CPU cell 11-1, and the response message and a CPU ID that indicates CPU 14-22 are stored in data area 25. Upon receiving the packets containing this response message at communication circuit 17-2, CPU cell 11-2 extracts the response message from the packets and transfers the response message to CPU 14-22.

Next, when CPU 14-31 of CPU cell 11-3 issues an input/output instruction for reading from result-reading port 28-1 of device 18-1, the input/output instructions are conveyed to device control unit 21-1 of device cell 12-1 by the same procedures that were used when issuing the input/output instruction for writing the second mode. Device control unit 21-1 reads result register 30-13 of device control information 22-13 that corresponds to CPU cell 11-3, which is the transmission origin, and transfers the content to communication circuit 20-1 as a response message. Communication circuit 20-1 transmits packets that contain this response message to the transmission origin, CPU cell 11-3. At this time, packet transmission destination ID 23 indicates CPU cell 11-3, transmission origin ID 24 indicates device cell 12-1, and the response message and a CPU ID that indicates CPU 14-31 are stored in data area 25. CPU cell 11-3, upon receiving packets that contain this response message at communication circuit 17-3, extracts the response message from the packets and transfers the response message to CPU 14-31.

Operation by the above-described procedures enables CPU 14-22 of CPU cell 11-2 that belongs to System A to, with respect to device 18-1, write the first mode to mode-setting port 26-1, write the first process to process-setting port 27-1, and read the processing results from result-reading port 28-1. In addition, CPU 14-31 of CPU cell 11-3 that belongs to System B is able to, with respect to device 18-1, write the second mode to mode-setting port 26-1, write the second process to process-setting port 27-1, and read the processing results from result-reading port 28-1.

In the multiprocessor system of the present embodiment, for example, a device may be provided in device cell 12-2 that is the same as device 18-1 belonging to device cell 12-1. In such a case, at the time of system start-up, the address information of device cell 12-1 is set in communication circuit 17-1 of CPU cell 11-1 as the address of the input/output port that corresponds to device 18-1 that is used by System A, and the address information of device cell 12-2 is set as the address of the input/output port that corresponds to device 18-2. In addition, the address information of device cell 12-1 is set in communication circuit 17-3 of CPU cell 11-3 as the address of the input/output port that corresponds to device 18-1 that is used by System B, and the address information of device cell 12-2 is set as the address of the input/output port that corresponds to device 18-2. Further, the address information of CPU cell 11-1 is set in communication circuit 17-2 of CPU cell 11-2 as the address of the input/output port that corresponds to device 18-1 and device 18-2 that are used by System A. In this type of configuration, System A and System B see device 18-1 and device 18-2 as devices that can be used.

Accordingly, the device drivers of each system can distribute load and thus improve performance of the system by using the two existing devices, device 18-1 and device 18-2. The reliability of the devices can be further improved by implementing fail-over. The number of devices required is two, and this number does not increase in proportion to the number of operating systems that operate in the multiprocessor system.

In the multiprocessor system of the present invention, moreover, device 18-1 in System A, which is made up of the two CPU cells CPU cell 11-1 and CPU cell 11-2, can be shown as two different devices 18-11 and 18-12. At the time of system start-up, the address information of device cell 12-1 is set in communication circuit 17-1 of CPU cell 11-1 as the address of the input/output port that corresponds to virtual device 18-11 that is used in System A, and CPU cell 11-2 is set as the address of the input/output port that corresponds to device 18-12. In addition, the address information of CPU cell 11-1 is set as the address of the input/output port that corresponds to device 18-11 that is used in System A, and the address information of device cell 12-1 is set as the address of the input/output port that corresponds to device 18-12. In this configuration, System A sees the two devices, device 18-11 and device 18-12, as usable devices.

Accordingly, even if the device driver that manages device 18-1 should simultaneously receive access requests from two application programs in System A, the access requests can be divided between device 18-11 and device 18-12. The need for exclusive control for accessing the same device is therefore eliminated, and system performance can be improved.

The multiprocessor system of the first embodiment can therefore enable the sharing of a device without altering the device driver of each operating system.

In addition, devices can be shared by means of simple hardware among a plurality of operating systems that operate in a multiprocessor system, whereby hardware costs can be reduced. Still further, the number of devices required for the improvement in reliability of devices and the distribution of load is fixed regardless of the number of operating systems that operate in the multiprocessor system, and hardware costs can therefore be reduced. Further, a device that is actually only one device can be shown as a plurality of virtual devices, and the plurality of virtual devices can therefore be divided when the device driver simultaneously receives access requests from two application programs. Accordingly, the need for implementing exclusive control for accessing the same device can be eliminated and system performance can be improved.

Second Embodiment

In the first embodiment, providing device control information 22 in device cell 12 that corresponds to each CPU cell 11 enables the sharing of a single device among a plurality of systems that operate under different operating systems. Accordingly, the existence of a multiplicity of CPU cells 11 necessitates a corresponding multiplicity of sets of device control information 22 and a corresponding increase in hardware costs. In addition, since the number of virtual devices that can be shown is limited by the number of CPU cells 11 that make up the system, it was not possible to show two virtual devices when the system is made up by only one CPU cell. The multiprocessor system of the present embodiment is an example in which CPU cells 11 and device control information 22 do not have a one-to-one correspondence.

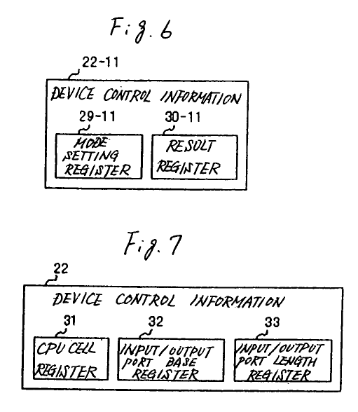

FIG. 7 is a block diagram showing the configuration of device control information in the multiprocessor system of the second embodiment of the present invention.

As shown in FIG. 7, the multiprocessor system of the second embodiment is a construction in which CPU cell register 31, input/output port base register 32, and input/output port length register 33 are provided in device control information 22 in addition to the registers that were provided in the first embodiment. The values of these registers are each set at the time of system start-up.

As an example, when sharing device 18-1 in the multiprocessor system that includes System A and System B shown in FIG. 3, two sets of device control information 22 are provided to correspond to System A and System B. Then, at the time of system start-up, the address information of device cell 12-1 is set in communication circuit 17-1 of CPU cell 11-1 as the address of input/output port that corresponds to device 18-1 that is used in System A, the address information of device cell 12-1 is set in communication circuit 17-3 of CPU cell 11-3 as the address of input/output port that corresponds to device 18-1 that is used in System B, and the address information of CPU cell 11-1 is set in communication circuit 17-2 of CPU cell 11-2 as the address of input/output port that corresponds to device 18-1 that is used in System A.

In addition, an ID that indicates CPU cell 11-1 is stored in CPU cell register 31 of device control information 22 that corresponds to System A, the base address of the input/output port that is set in System A is stored in input/output port base register 32, and the range is set in input/output port length register 33.

Further, an ID that indicates CPU cell 11-3 is stored in CPU cell register 31 of device control information 22 that corresponds to System B, that base address of the input/output port that is set in System B is stored in input/output port base register 32, and the range is set in input/output port length register 33.

Device control unit 21, upon receiving input/output instructions whose transmission origin is a particular system (CPU cell 11), searches the corresponding device control information 22, matches the transmission source ID with the content of CPU cell register 31, and moreover, detects whether the number of the input/output port is within the range that is indicated by input/output port base register 32 and input/output port length register 33 (equal to or greater than the value of input/output port base register 32 to less than the value of input/output port base register 32+input/output port length register 33). Device control unit 21 then uses device control information 22 that has been detected to control device 18 similarly to the first embodiment.

Thus, providing device control information 22 with CPU cell register 31, input/output port base register 32, and input/output port length register 33, and then searching the appropriate device control information 22 when input/output instructions are received enables a construction in which there is no one-to-one correspondence between CPU cells 11 and device control information 22. In other words, a construction is possible in which any number of sets of device control information 22 are prepared regardless of the number of CPU cells 11, and the assignment of CPU cells 11 and this device control information 22 can also be set freely. As a result, the preparation of, for example, two sets of device control information 22 regardless of the number of CPU cells allows device 18 to be shared by two systems, and enables a reduction in hardware costs.

Further, by assigning two sets of device control information 22 to the same CPU cell 11 while setting different input/output ports allows two devices to be shown even though the system is made up by only one CPU cell 11.

Third Embodiment

In the first and second embodiments, no suggestion was offered regarding the manner of dividing the use of devices 18 when a plurality of identical devices 18 are assigned to a single operating system. Consequently, as in the prior art, no solution is provided for the problem of degradation of the latency and turnaround time of input/output instructions to these devices 18 when devices 18 that are used are assigned to different CPU cells 11.

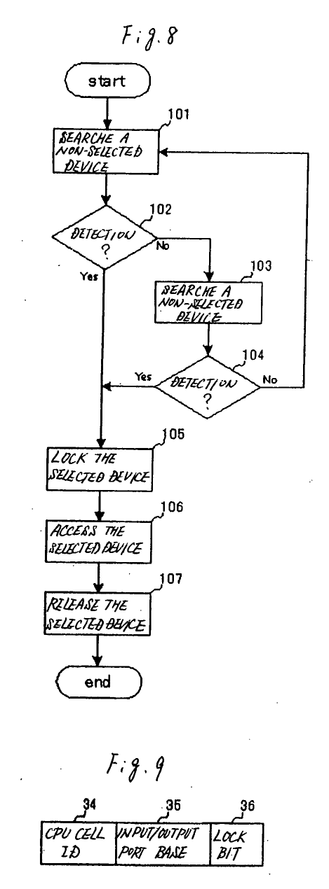

FIG. 8 is a flow chart showing the processing steps of the third embodiment of the multiprocessor system of the present invention, and FIG. 9 is a table showing information that is held by device drivers that are provided for each system of the multiprocessor system of the third embodiment.

FIG. 8 shows the procedures for dividing use by a device driver when a plurality of similar devices is assigned to one operating system. The device driver holds information on usable devices in a table format, and FIG. 9 shows the composition of each entry of such a table.

CPU cell ID 34 shown in FIG. 9 shows the ID of a CPU cell that is assigned to a corresponding device 18. Input/output port base 35 stores the base address of the input/output port that is provided in corresponding device 18. The information of this CPU cell ID 34 and input/output port base 35 is set at the time of system start-up. Lock-bit 36 indicates whether device 18 is in use or not.

As shown in FIG. 8, when an access request for device 18 is received from any application, the device driver searches the table in Step 101 and detects one entry in which the content of CPU cell ID 34 matches the ID of the CPU cell that contains CPU 14 in which the device driver is operating, and moreover, in which lock-bit 36 is “0”.

Next, it is determined in Step 102 whether or not a relevant entry was detected, and if an entry has been detected, the process proceeds to Step 105.

On the other hand, if a relevant entry is not detected in Step 102, the table is again searched in Step 103, and one entry is detected in which lock-bit 36 is “0”. In Step 104, it is again determined whether or not a relevant entry was detected, and if a relevant entry has been detected, the process proceeds to Step 105, but if no entry is detected, the process returns to Step 101.

In Step 105, the detected entry is selected as device 18 that is to be used, and lock-bit 36 of this entry is set to “1”.

Next, in Step 106, the input/output port number of device 18 that is to be accessed is calculated based on the content of input/output port base 35 of the detected entry, and device 18 is accessed.

When access is completed to device 18, lock-bit 36 of the detected entry is set to “0” in Step 107.

By the process of the above-described steps, the device driver preferentially uses device 18 that was assigned to communication circuit 17 of the same CPU cell 11. In such a case, the latency of an input/output instruction to device 18 is the time for a round-trip of network 13. The turnaround time can therefore be made shorter than the time for accessing device 18 that entails a round trip of network 13.

As a result, the multiprocessor system of the third embodiment allows a decrease of the turnaround time and latency of the input/output instruction to the device when a plurality of similar devices is assigned to one operating system.

Fourth Embodiment

As a modification of the first to third embodiments, the multiprocessor system of the fourth embodiment is a construction that includes a plurality of devices 18 in device cell 12. In such a case, device control unit 21 and device control information 22 that correspond to each device 18 are prepared in device cell 12. Access to each device 18 is realized by way of a corresponding device control unit 21.

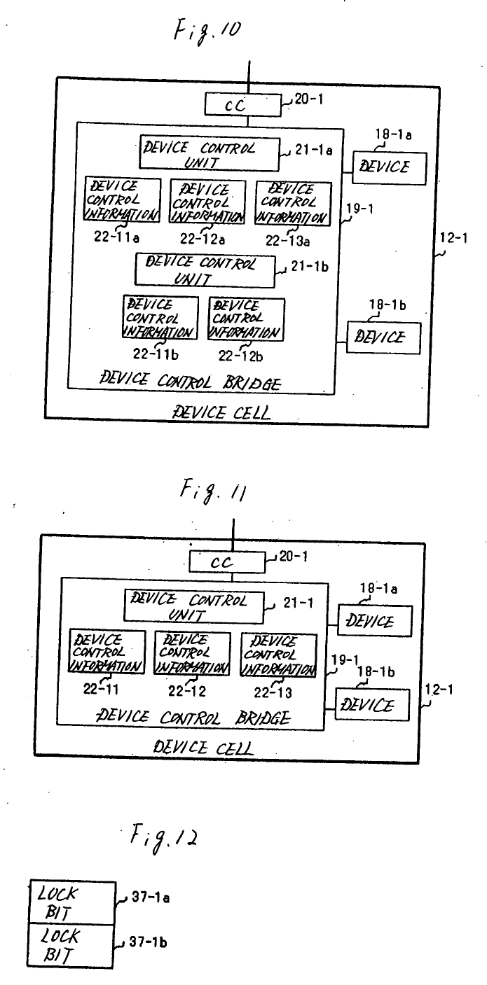

FIG. 10 is a block diagram that shows the construction of a device cell that is included in the multiprocessor system of the fourth embodiment.

As shown in FIG. 10, the multiprocessor system of the present embodiment is a configuration in which device 18-1a and device 18-1b are provided in device cell 12-1, and in which device 18-1a and device 18-1b are each connected to device control bridge 19-1.

Device control bridge 19-1 is provided with: device control unit 21-1a and device control information 22-11a, 12a, and 13a that correspond to device 18-1a; and device control unit 21-1b and device control information 22-11b and 12b that correspond to device 18-1b.

In such a construction, when an input/output instruction to device 18-1a is received at communication circuit 20-1 of device cell 12-1 that is shown in FIG. 10, device 18-1a is controlled by using device control unit 21-1a. When an input/output instruction to device 18-1b is received, device 18-1b is controlled by using device control unit 21-1b.

In the multiprocessor system of the present embodiment, a plurality of the same type of device is provided in device cell 12, and these devices can be controlled by one device control unit 21. The construction of device control unit 21 in such a case is shown in FIG. 11.

FIG. 11 is a block diagram showing the construction of a modification of the device cell included in the multiprocessor system of the fourth embodiment.

Device cell 12-1 that is shown in FIG. 11 is a construction that is provided with device 18-1a and device 18-1b, which are the same type of device, device 18-1a and device 18-1b each being connected to device control bridge 19-1.

Device control bridge 19-1 is provided with device control unit 21-1a and device control information 22-11a, 12a, and 13a that all correspond to device 18-1a and device 18-1b.

Device control unit 21 monitors the state of use of each of device 18-1a and device 18-1b and distributes load. If either of the devices becomes unusable due to a failure, fail-over is realized by using the other device, whereby an improvement in reliability can be realized.

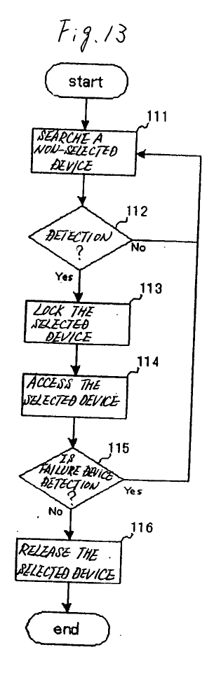

FIG. 12 is a table showing the information that is held by the device control unit shown in FIG. 11.

As shown in FIG. 12, device control unit 21-1 of the present embodiment holds lock-bit 37-1a that corresponds to device 18-1a and lock-bit 37-1b that corresponds to device 18-1b. These lock-bits 37-1a and 37-1b show whether each of device 18-1a and device 18-1b can be used. For example, lock-bit 37-1a is “0” when device 18-1a can be used, and becomes “1” when device 18-1a is currently being used or has become unusable due to a failure.

The operation of device control unit of the multiprocessor system of the fourth embodiment is next explained with reference to FIG. 13.

FIG. 13 is a flow chart showing the processing steps of the fourth embodiment of the multiprocessor system of the present invention. FIG. 13 shows operations for a case in which device control unit 21-1 receives input/output instructions by way of communication circuit 20-1, carries out processing that corresponds to these input/output instructions, and thus is actually compelled to access a device.

As shown in FIG. 13, device control unit 21-1, upon receiving input/output instructions by way of communication circuit 20-1, searches lock-bit 37-1 having the value “0” to find a device that can be used in Step 111.

It is next determined in Step 112 whether or not lock-bit 37-1 having a value of “0” was detected, and if lock-bit 37-1 with a value “0” was detected (in the following explanation, it is assumed that lock-bit 37-1a was “0”), the process moves to Step 113. If not detected, the process returns to Step 111.

In Step 113, device 18-1a that corresponds to lock-bit 37-1a that was detected is selected as the device that is to be used, and “1” is written to lock-bit 37-1a. Device 18-1a that was selected in Step 113 is then accessed, and the completion of processing is awaited.

In Step 115, it is determined whether or not a failure occurred in device 18-1a, and if a failure of device 18-1a is detected while waiting for the completion of processing, the process returns to Step 110. On the other hand, if processing in device 18-1a is completed normally, the process continues to Step 116. In Step 116, “0” is written to lock-bit 37-1a.

Processing by the above-described steps allows device control unit 21-1 to use device 18-1b even when, for example, another input/output instruction is received and the need arises to access device 18-1 while device 18-1a is being accessed in accordance with a particular input/output instruction. The load of accessing device 18-1 can thus be distributed by using device 18-1a and device 18-1b.

Alternatively, if a failure should occur while device 18-1a is being used, processing can be continued by using the other device 18-1b, whereby fail-over can be realized in the event of a failure.

Thus, in the multiprocessor system of the fourth embodiment, a plurality of devices can be connected to a device cell. In addition, by connecting the same type of devices and effecting control by a single device control unit 21, load can be distributed and fail-over implemented without altering the device drivers.

Fifth Embodiment

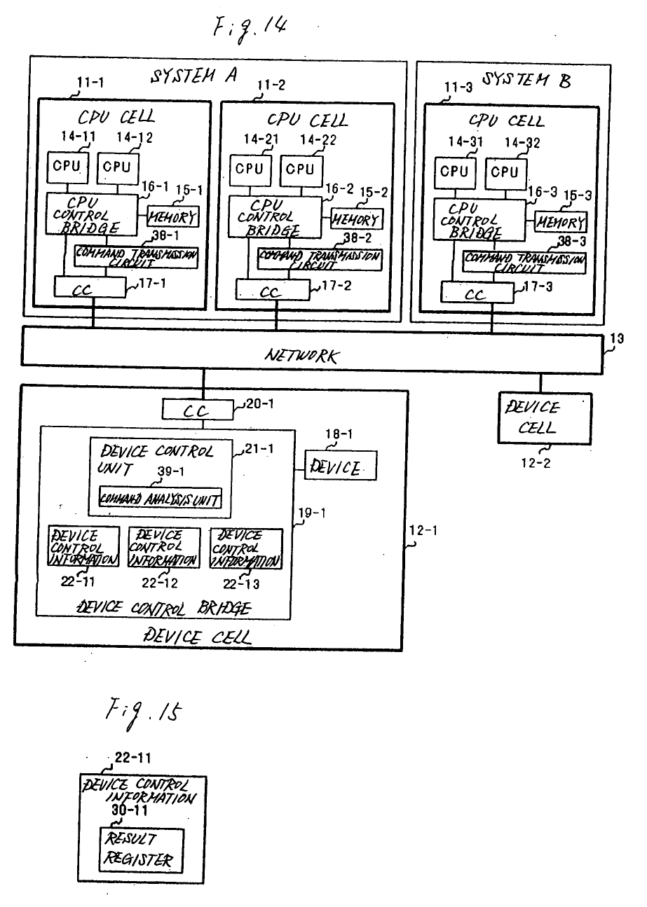

FIG. 14 is a block diagram showing the construction of the fifth embodiment of the multiprocessor system of the present invention, and FIG. 15 is a block diagram showing the construction of device control information that is provided in the device control bridge that is shown in FIG. 14.

As shown in FIG. 14, the multiprocessor system of the fifth embodiment differs from the first embodiment in that CPU cells 11 are provided with command transmission circuits 38, and device control unit 21 of device cell 12 is provided with command analysis unit 39.

By means of command transmission circuits 38, CPU cells 11 generate commands in which a plurality of input/output instructions that are issued from CPUs 14 is combined. These commands are converted to packets by means of communication circuits 17 and transmitted to network 13. Device cell 12, upon receiving packets from network 13 by means of communication circuit 20, transfers the commands that have been extracted from the packets to device control unit 21.

When device control unit 21 receives commands that are not input/output instructions, device control unit 21 delivers the commands to command analysis unit 39 for analysis. Command analysis unit 39 breaks down the commands into a plurality of input/output instructions and returns these input/output instructions to device control unit 21. Device control unit 21 executes processing in accordance with the plurality of input/output instructions that are returned from command analysis unit 39.

As in the first embodiment, devices 18 are provided with: mode-setting port 26 for setting the type of operating mode, process-setting port 27 for setting the type of process, and result-reading port 28 for storing the results of processing. In addition, CPUs 14 are assumed to simultaneously generate a write access to mode-setting port 26 and a write access to process-setting port 27. In such a case, device control information 22 is constituted only by result registers 30, as shown in FIG. 15.

The operation of the multiprocessor system of the present embodiment is next described taking as an example a case in which one device 18-1 is shared by the two systems shown in FIG. 14, System A and System B. At the time of system start-up, the address information of device cell 12-1 is set in communication circuit 17-1 of CPU cell 11-1 as the address of input/output port that corresponds to device 18-1 that is used by System A; the address information of device cell 12-1 is set in communication circuit 17-3 of CPU cell 11-3 as the address of input/output port that corresponds to device 18-1 that is used in System B; and the address information of CPU cell 11-1 is set in communication circuit 17-2 of CPU cell 11-2 as the address of input/output port that corresponds to device 18-1 that is used in System A.

In addition, CPU 14-22 of CPU cell 11-2 that belongs to System A, with respect to device 18-1, writes the first mode to mode-setting port 26-1, writes the first process to process-setting port 27-1, and reads the results from result-reading port 28-1. With respect to device 18-1, CPU 14-31 of CPU cell 11-3 that belongs to System B writes the second mode to mode-setting port 26-1, writes the second process to process-setting port 27-1, and reads the results from result-reading port 28-1. This explanation relates to a case in which System A and System B simultaneously access device 18-1.

First, when CPU 14-22 of CPU cell 11-2 generates a command in which input/output instructions are combined for setting to the first mode and to the first process, packets that contain the command are transmitted by communication circuit 17-2 by way of network 13 to CPU cell 11-1 in accordance with address information that was set at the time of system start-up. At this time, transmission destination ID 23 of the transmitted packets shows CPU cell 11-1, transmission origin ID 24 shows CPU cell 11-2, and the command that was issued at CPU cell 11-2 and a CPU ID that indicates CPU 14-22 are stored in data area 25.

CPU cell 11-1, upon receiving the packets that were transmitted from CPU cell 11-2 at communication circuit 17-1, transmits the relevant packets from communication circuit 17-1 to the relevant device cell 12-1 by way of network 13 in accordance with the address information that was set at the time of system start-up. At this time, transmission destination ID 23 of the packets indicates device cell 12-1, transmission origin ID 24 shows CPU cell 11-1, and the command that was issued at CPU cell 11-2 and request origin ID that indicates CPU cell 11-2 are stored in data area 25.

Device cell 12-1, upon receiving packets that contain this command at communication circuit 20-1, extracts the command from the packets and transfers the command to device control unit 21-1. Device control unit 21-1 analyzes the received command at command analysis unit 39-1 and thus acquires the input/output instruction to mode-setting port 26-1 for setting to the first mode and the input/output instruction to process-setting port 27-1 for setting to the first process. Device control unit 21-1 then sets mode-setting port 26-1 of device 18-1 to the first mode and sets process-setting port 27-1 to the first process.

Device 18-1 receives the writing for process-setting port 27-1, executes the first process of the first mode, and writes the processing results to result-reading port 28-1.

Device control unit 21-1 monitors result-reading port 28-1, and upon recognizing that processing results have been written, reads the processing results from result-reading port 28-1 and writes the content of the processing results to results register 30-11 that corresponds to CPU cell 11-1 that was indicated by the transmission origin ID of the packets.

Next, when CPU 14-31 of CPU cell 11-3 generates a command in which input/output instructions for setting to the second mode and to the second process are combined, CPU cell 11-3 uses command transmission circuit 38-3 to transmit the command to device cell 12-1. At this time, transmission destination ID 23 of the packets that are supplied as output from communication circuit 17-3 of CPU cell 11-3 indicates device cell 18-1, transmission origin ID 24 indicates CPU cell 11-3, and the command is stored in data area 25.

Device cell 12-1, upon receiving the packets that contain this command at communication circuit 20-1, extracts the command from the packets and transfers the command to device control unit 21-1. Device control unit 21-1 analyzes the received command at command analysis unit 39-1, and thus acquires the input/output instruction for setting the second mode to mode-setting port 26-1 and the input/output instruction for setting the second process to process-setting port 27-1. Device control unit 21-1 then sets mode-setting port 26-1 of device 18-1 to the second mode and sets process-setting port 27-1 to the second process.

Device 18-1 receives the writing to process-setting port 27-1, executes the second process of the second mode, and writes the processing results to result-reading port 28-1.

Device control unit 21-1 monitors result-reading port 28-1, and upon recognizing that processing results have been written, reads the processing results from result-reading port 28-1 and writes the content of the processing results to result register 30-13 that corresponds to CPU cell 11-3 that is indicated by the transmission origin ID of the packets.

Next, when CPU 14-22 of CPU cell 11-2 issues an input/output instruction for reading to result-reading port 28-1 of device 18-1, CPU cell 11-2 uses communication circuit 17-2 to generate packets that contain the input/output instruction and transmits the packets to CPU cell 11-1 by way of network 13. At this time, transmission destination ID 23 of the packets that are supplied as output from communication circuit 17-2 of CPU cell 11-2 indicates CPU cell 11-1, transmission origin ID 24 indicates CPU cell 11-2, and the input/output instruction and CPU ID that indicates CPU 14-22 are stored in data area 25.

CPU cell 11-1, upon receiving the packets that contain this command at communication circuit 17-1, transmits the packets that contain the input/output instruction that was received from CPU cell 11-2 to appropriate device cell 12-1 by way of network 13 in accordance with the address information that was set at the time of system start-up. At this time, transmission destination ID 23 of the packets indicates device cell 12-1, transmission origin ID 24 indicates CPU cell 11-1, and the input/output instruction, a CPU ID that indicates CPU 14-22, and a request origin ID that indicates CPU cell 11-2 are stored in data area 25.

Device cell 12-1, upon receiving packets that contain these input/output instructions at communication circuit 20-1, extracts the input/output instruction from the packets and transfers the input/output instruction to device control unit 21-1. Device control unit 21-1 reads result register 30-11 of device control information 22-11 that corresponds to CPU cell 11-1, which is the transmission origin, and transfers the content of result register 30-11 to communication circuit 20-1 as a response message. Communication circuit 20-1 transmits packets that contain this response message to CPU cell 11-1, which is the transmission origin. At this time, transmission destination ID 23 of the packets indicates CPU cell 11-1, transmission origin ID 24 indicates device cell 12-1, and the response message, a CPU ID that indicates CPU 14-22, and a request origin ID that indicates request origin CPU cell 11-2 are stored in data area 25.

CPU cell 11-1, upon receiving the packets that contain the response message from device cell 12-1 at communication circuit 17-1, delivers the packets to CPU cell 11-2 by way of network 13. At this time, transmission destination ID 23 of the packets indicates CPU cell 11-2, transmission origin ID 24 indicates CPU cell 11-1, and the response message and a CPU ID that indicates CPU 14-22 are stored in data area 25.

CPU cell 11-2, upon receiving the packets that contain this response message at communication circuit 17-2, extracts the response message from the packets and transfers the response message to CPU 14-22.

Next, when CPU 14-31 of CPU cell 11-3 issues an input/output instruction for reading to result-reading port 28-1 of device 18-1, CPU cell 11-3 uses communication circuit 17-3 to generate packets that contain the input/output instruction and transmits the packets to device cell 12-1 by way of network 13 in accordance with the address information that was set at the time of system start-up. At this time, transmission destination ID 23 of the packets that are supplied as output from communication circuit 17-3 of CPU cell 11-3 indicates device cell 12-1, transmission origin ID 24 indicates CPU cell 11-3, and the input/output instruction and a CPU ID that indicates CPU 14-31 are stored in data area 25.

Device cell 12-1, upon receiving the packets that contain this input/output instruction at communication circuit 20-1, extracts the input/output instruction from the packets and transfers the input/output instruction to device control unit 21-1. Device control unit 21-1 reads result register 30-13 of device control information 22-13 that corresponds to CPU cell 11-3, which is the transmission origin, and transfers the content of result register 30-13 to communication circuit 20-1 as a response message. Communication circuit 20-1 transmits the packets that contain this response message to CPU cell 11-3, which is the transmission origin. At this time, transmission destination ID 23 of the packets indicates CPU cell 11-3, transmission origin ID 24 indicates device cell 12-1, and the response message and a CPU ID that indicates CPU 14-31 are stored in data area 25.

CPU cell 11-3, upon receiving the packets that contain this response message at communication circuit 17-3, extracts the response message from the packets and transfers the response message to CPU 14-31.

The operation by the above-described procedures enables CPU 14-22 of CPU cell 11-2 that belongs to System A to, with respect to device 18-1, write the first mode to mode-setting port 26-1, write the first process to process-setting port 27-1, and read the processing results from result-reading port 28-1. Further, CPU 14-31 of CPU cell 11-3 that belongs to System B is able to, with respect to device 18-1, write the second mode to mode-setting port 26-1, write the second process to process-setting port 27-1, and read the processing results from result-reading port 28-1.

Further, in the multiprocessor system of the present embodiment, device cell 12-2 may, for example, be provided with a device that is similar to device 18-1 that is included in device cell 12-1. In such a case, at the time of system start-up, the address information of device cell 12-1 is set in communication circuit 17-1 of CPU cell 11-1 as the address of the input/output port that corresponds to device 18-1 that is used in System A, and the address information of device cell 12-2 is set as the address of the input/output port that corresponds to device 18-2. Further, the address information of device cell 12-1 is set in communication circuit 17-3 of CPU cell 11-3 as the address of the input/output port that corresponds to device 18-1 that is used in System B, and the address information of device cell 12-2 is set as the address of the input/output port that corresponds to device 18-2. In addition, address information of CPU cell 11-1 is set in communication circuit 17-2 of CPU cell 11-2 as the address of the input/output port that corresponds to device 18-1 and device 18-2 that are used in System A. In this configuration, System A and System B view device 18-1 and device 18-2 as usable devices.

Accordingly, the device drivers of each system employ the two available devices, device 18-1 and device 18-2, whereby load is distributed and performance of the system can be improved. In addition, the reliability of the devices can also be improved by implementing fail-over. Moreover, the number of devices that is necessary for realizing these improvements is two, and this number need not be increased in proportion to the number of operating systems that operate in the multiprocessor system.

Further, in System A that is constituted by two CPU cells, CPU cell 11-1 and CPU cell 11-2, in the multiprocessor-system of the present embodiment, device 18-1 can, for example, be shown as two different devices, device 18-11 and device 18-12. At the time of system start-up, the address information of device cell 12-1 is set in communication circuit 17-1 of CPU cell 11-1 as the address of the input/output port that corresponds to virtual device 18-11 that is used in System A, and CPU cell 11-2 is set as the address of the input/output port that corresponds to device 18-12. In addition, the address information of CPU cell 11-1 is set in communication circuit 17-2 of CPU cell 11-2 as the address of the input/output port that corresponds to device 18-11 that is used in System A, and the address information of device cell 12-1 is set as the address of the input/output port that corresponds to device 18-12. In this configuration, System A sees the two devices, device 18-11 and device 18-12, as usable devices.

Accordingly, in System A, even in the event that the device driver that controls device 18-1 simultaneously receives access requests from two application programs, the use of device 18-1 can be divided between device 18-11 and device 18-12. Accordingly, the need for implementing exclusive control for realizing access to the same device can be eliminated, and the system performance can be improved.

As a result, the multiprocessor system of the fifth embodiment enables sharing of devices without alteration of the device drivers of each operating system.

In addition, the sharing of devices among the plurality of operating system that operate in the multiprocessor system can be realized by simple hardware, and hardware costs can therefore be reduced. Hardware costs can be further reduced because the number of devices necessary for distributing load and improving reliability of the devices is fixed regardless of the number of operating systems that operate in the multiprocessor system. Still further, a single device that actually exists can be shown as a plurality of virtual devices, and as a result, even when the device driver simultaneously receives access requests from two application programs, these access requests can be accommodated by dividing between the plurality of virtual devices. The need for implementing exclusive control for accessing the same device is therefore eliminated, and the system performance can be improved.

The construction shown in the fifth embodiment (a construction in which command transmission circuits 38 are provided in CPU cells 11, and command analysis units 39 are provided in device control units 21 of device cells 12) can also be applied to the previously described second to fourth embodiments.

Sixth Embodiment

In the fifth embodiment, an example was described in which input/output instructions to mode-setting port 26-1 and process-setting port 27-1 that are provided in device 18-1 were combined in one command. The sixth embodiment is a case in which an input/output instruction for result-reading port 28-1 is added to the command. In this case, there is no need for device control information 22 to hold any information. The construction of the multiprocessor system is the same as the fifth embodiment shown in FIG. 14 and redundant explanation is therefore here omitted.

The operation of the multiprocessor system of the present embodiment is next described taking as an example a case in which the two systems, System A and System B, that are shown in FIG. 14 share one device, device 18-1. At the time of system start-up, the address information of device cell 12-1 is set in communication circuit 17-1 of CPU cell 11-1 as the address of the input/output port that corresponds to device 18-1 that is used in System A, the address information of device cell 12-1 is set in communication circuit 17-3 of CPU cell 11-3 as the address of the input/output port that corresponds to device 18-1 that is used in System B, and the address information of CPU cell 11-1 is set in communication circuit 17-2 of CPU cell 11-2 as the address of the input/output port that corresponds to device 18-1 that is used in System A.

In addition, CPU 14-12 of CPU cell 11-1 that belongs to System A, with respect to device 18-1, writes the first mode to mode-setting port 26-1, writes the first process to process-setting port 27-1, and reads the results from result-reading port 28-1. CPU 14-31 of CPU cell 11-3 that belongs to System B, with respect to device 18-1, writes the second mode to mode-setting port 26-1, writes the second process to process-setting port 27-1, and reads the results from result-reading port 28-1. A case is here described in which System A and System B simultaneously access device 18-1.

First, when CPU 14-22 of CPU cell 11-2 generates a command in which are combined: input/output instructions for setting the first mode and first process and the address on memory 15 that stores the processing results; packets containing the command are transmitted by communication circuit 17-2 by way of network 13 to CPU cell 11-1 in accordance with the address information that was set at the time of system start-up. Transmission destination ID 23 of the packets that are transmitted at this time indicates CPU cell 11-1, transmission origin ID 24 indicates CPU cell 11-2, and the command that was issued by CPU cell 11-2 and a CPU ID that indicates CPU 14-22 are stored in data area 25.

CPU cell 11-1, upon receiving the packets at communication circuit 17-3 that were transmitted from CPU cell 11-2, transmits the packets from communication circuit 17-1 by way of network 13 to the appropriate device cell 12-1 in accordance with the address information that was set at the time of system start-up. Transmission destination ID 23 of the packets at this time indicates device cell 12-1, transmission origin ID 24 indicates CPU cell 11-1, and the command that was issued at CPU cell 11-2 and a request origin ID that indicates CPU cell 11-2 are stored in data area 25.

Device cell 12-1, upon receiving the packets that contain this command at communication circuit 20-1, extracts the command from the packets and transfers the command to device control unit 21-1. Device control unit 21-1 analyzes the command that is received by means of command analysis unit 39-1 and thus acquires: the input/output instruction to mode-setting port 26-1 for setting to the first mode, the input/output instruction to process-setting port 27-1 for setting to the first process, and the input/output instruction for reading from result-reading port 28-1. Device control unit 21-1 then sets mode-setting port 26-1 of device 18-1 to the first mode, and sets the process-setting port 27-1 to the first process.

Device 18-1 receives the write-in to process-setting port 27-1, executes the first process of the first mode, and writes the processing results to result-reading port 28-1.

Device control unit 21-1 monitors result-reading port 28-1, and upon recognizing that processing results have been written, reads the processing results from result-reading port 28-1 and transfers the content of these processing results to communication circuit 20-1 as a response message. Communication circuit 20-1 transmits packets containing this response message to CPU cell 11-1, which is the transmission origin. At this time, transmission destination ID 23 of the packets indicates CPU cell 11-1, transmission origin ID 24 indicates device cell 12-1, and the response message and an address that is contained in the received packets are stored in data area 25.

CPU cell 11-1, upon receiving the packets that contain this response message at communication circuit 17-1, extracts the response message from the packets and processes the response message as a memory access instruction to write the response message to the designated address.

When CPU 14-31 of CPU cell 11-3 generates a command in which are combined: input/output instructions for setting the second mode and the second process and the address on memory 15 that stores the processing results; CPU cell 11-3 uses command transmission circuit 38-1 to transmit the command to device cell 12-1. At this time, transmission destination ID 23 of the packets that are supplied as output from communication circuit 17-1 of CPU cell 11-1 indicates device 18-1, transmission origin ID 24 indicates CPU cell 11-3, and the command is stored in data area 25.

Device cell 12-1, upon receiving packets that contain this command at communication circuit 20-1, extracts the command from the packets and transfers the command to device control unit 21-1. Device control unit 21-1 analyzes the received command by means of command analysis unit 39-1, and thus acquires the input/output instruction to mode-setting port 26-1 for setting to the second mode, the input/output instruction to process-setting port 27-1 for setting to the second process, and the input/output instruction for reading from result-reading port 28-1. Device control unit 21-1 then sets mode-setting port 26-1 of device 18-1 to the second mode, and sets the process-setting port 27-1 to the second process.

Device 18-1 receives the write-in to process-setting port 27-1, executes the second process of the second mode, and writes the processing results to result-reading port 28-1.

Device control unit 21-1 monitors result-reading port 28-1, and upon recognizing that processing results have been written, reads the processing results from result-reading port 28-1, and transfers the content as a response message to communication circuit 20-1. Communication circuit 20-1 then transmits packets containing this response message to CPU cell 11-3, which is the transmission origin. At this time, transmission destination ID 23 of the packets indicates CPU cell 11-3, transmission origin ID 24 indicates device cell 12-1, and the response message and the address that was contained in the packets that were received are stored in data area 25.

CPU cell 11-3, upon receiving the packets that contain this response message at communication circuit 17-3, extracts the response message from the packets and processes the response message as a memory access instruction for writing the response message to the designated address.

In this state, CPU 14-22 and CPU 14-31 verify that the processing results have been written to the address in memory 15 that was designated and then read the content and acquire the processing results.

Processing by the above-described procedures enables CPU 14-22 of CPU cell 11-2 that belongs to System A to, with respect to device 18-1, write the first mode to mode-setting port 26-1, write the first process to process-setting port 27-1, and read the processing results from the address in memory 15 that was designated. In addition, CPU 14-31 of CPU cell 11-3 that belongs to System B is enabled to, with respect to device 18-1, write the second mode to mode-setting port 26-1, and read the processing results, from the designated address on memory 15.

Accordingly, the multiprocessor system of the sixth embodiment, in addition to the effects obtained in the fifth embodiment, has the effect of reducing traffic on network 13 caused by input/output instructions as well as the effect of simplifying device control information 22.

Seventh Embodiment

In the sixth embodiment, a response message is transmitted to CPU cell 11-1, the transmission origin, when packets are received in device cell 12-1. In the seventh embodiment, device cell 12-1 selects the transmission destination of packets that contain a response message. For this purpose, communication circuits 17 of each of CPU cells 11 hold system identifiers for specifying the system to which the communication circuits 17 belong. Communication circuits 20 of device cells 12 also hold lists of CPU cells 11 that correspond to these system identifiers.

In the example shown in FIG. 14, at the time of system start-up, not only is the address information of device cell 12-1 set in communication circuit 17-1 of CPU cell 11-1 as the address of the input/output port that corresponds to device 18-1 that is used in System A, but a system identifier that indicates System A is also stored. In communication circuit 17-3 of CPU cell 11-3, moreover, not only is the address information of device cell 12-1 set as the address of the input/output port that corresponds to device 18-1 that is used in System B, but a system identifier that indicates System B is also stored. The configuration of the multiprocessor system is equivalent to that of the sixth embodiment that was shown in FIG. 14, and redundant explanation is therefore here omitted.

The operation of the multiprocessor system of the present embodiment is next described for a case in which one device, device 18-1, is shared by System A and System B, the two systems shown in FIG. 14.

In this case, CPU 14-22 of CPU cell 11-2 that belongs to System A, with respect to device 18-1, writes the first mode to mode-setting port 26-1, writes the first process to process-setting port 27-1, and reads the results from result-reading port 28-1.

When CPU 14-22 of CPU cell 11-2 generates a command in which are combined input/output instructions for setting the first mode and the first process and an address on memory 15 for storing the processing results, packets that contain the command are transmitted to CPU cell 11-1 by way of network 13 by means of communication circuit 17-2 in accordance with the address information that was set at the time of system start-up. At this time, transmission destination ID 23 of the transmitted packets indicates CPU cell 11-1, transmission origin ID 24 indicates CPU cell 11-2, and the command that was issued by CPU cell 11-2 and a CPU ID that indicates CPU 14-22 are stored in data area 25.

CPU cell 11-1, upon receiving the packets that are transmitted from CPU cell 11-2 at communication circuit 17-1, transmits the packets from communication circuit 17-1 to the appropriate device cell 12-1 by way of network 13. At this time, transmission destination ID 23 of the packets indicates device cell 12-1, transmission origin ID 24 indicates CPU cell 11-1, and the command that was issued by CPU cell 11-2, a request origin ID that indicates CPU cell 11-2, and the system identifier that indicates System A that was set at the time of system start-up are stored in data area 25.

Device cell 12-1, upon receiving the packets that contain this command at communication circuit 20-1, extracts the command from the packets and transmits the command to device control unit 21-1. Device control unit 21-1 analyzes the received command at command analysis unit 39-1 and thus acquires the input/output instruction to mode-setting port 26-1 for setting to the first mode, the input/output instruction to process-setting port 27-1 for setting to the first process, and the input/output instruction for reading from result-reading port 28-1. Device control unit 21-1 then sets the first mode in mode-setting port 26-1 and sets the first process in process-setting port 27-1.

Device 18-1 receives the write-in to process-setting port 27-1, executes the first process of the first mode, and writes the processing results to result-reading port 28-1.

Device control unit 21-1 monitors result-reading port 28-1, and upon recognizing that processing results have been written, reads the processing results from result-reading port 28-1 and transfers the content of these processing results to communication circuit 20-1 as a response message.

At this stage, System A is altered such that the system is made up only by CPU cell 11-2, and the system configuration information of communication circuit 20-1 is altered.

Communication circuit 20-1 selects any one of CPU cells 11 that make up that system based on the system identifiers that were contained in the received packets and the system configuration information that were held and transmits packets that contain a response message to this CPU cell 11. In this case, System A is made up by only CPU cell 11-2, and communication circuit 20-1 therefore transmits the packets that contain the response message to CPU cell 11-2. At this time, transmission destination ID 23 of the packets indicates CPU cell 11-2, transmission origin ID 24 indicates device cell 12-1, and the response message and the address that was contained in the received packets are stored in data area 25.

CPU cell 11-2, upon receiving the packets from device cell 12-1, processes the response message as a memory access instruction for writing the response message to the designated address. CPU cell 11-2 then verifies that the processing results have been written to the designated address on memory 15, reads the content, and thus acquires the processing results.

Operation by the above-described steps allows a response message to be returned correctly to the system that issued a command even when the system configuration has been altered. As a result, the system configuration can be modified even when a command is being processed in a device cell.

In the multiprocessor system of the present embodiment, moreover, when selecting CPU cell 11 to which a response message is to be returned in communication circuit 20-1 of device cell 12-1, the load of the CPU cell or network 13 can be distributed by carrying out a round-robin or random selection of a CPU cell that is in the same system as the CPU cell that issued the command.

In addition to the effects that were obtained in the sixth embodiment, the seventh embodiment allows a response message to be returned correctly even when the system configuration is altered while processing is being carried out in device 18. In addition, the load of network 13 and CPU cell 11 can be distributed.

Finally, as a modification of the above-described first to seventh embodiments, a portion of the functions that were realized by the above-described device control unit 21 may be realized by providing a processor in device control unit 21 and then operating the processor by a software program.

While preferred embodiments of the present invention have been described using specific terms, such description is for illustrative purposes only, and it is to be understood that changes and variations may be made without departing from the spirit or scope of the following claims.

What is claimed is:

1. A multiprocessor system comprising:
a plurality of CPU cells that are each provided with at least one CPU wherein said CPU cells are divided among a plurality of groups, each of said groups operating under a different operating system; and
device cells that are connected to said CPU cells by way of a network, comprising;
devices that are shared among said plurality of CPU cells; and
device control units that are each provided with device control information for controlling a plurality of types of processing that can be executed by said devices, that are each provided with said device control unit that, upon receiving commands from said CPU cells, searches device control information that corresponds to the originator of said command and causes said devices to execute processing that is designated by said device control information that has been updated by said command.

2. The multiprocessor system according to claim 1, wherein said device control information is provided to correspond to each of said plurality of CPU cells.

3. The multiprocessor system according to claim 1, wherein said device control information is provided in any number of sets that does not match the number of said groups or the number of said CPU cells.

4. The multiprocessor system according to claim 1, wherein:
said CPU cells hold, in table format, information on said devices that said CPU cells can use; and
each of said CPU cells preferentially uses devices that are assigned to that CPU cell at the time of system start-up.

5. The multiprocessor system according to claim 1, wherein:
said device cells are provided with a plurality of similar devices; and
said device control units cause any device from among said plurality of devices to execute processes that are designated by said device control information.

6. The multiprocessor system according to claim 1, wherein:
said CPU cells are each provided with a command transmission circuit for generating commands in which are combined a plurality of instructions that are issued from said CPUs;
said device cells are each provided with a command analysis unit for parsing said commands and extracting a plurality of instructions; and
said device control units cause said devices to execute processing that is designated by said device control information that has been updated by the plurality of extracted instructions.

7. The multiprocessor system according to claim 1, wherein:
said CPU cells hold system identifiers for specifying said groups to which said CPU cells belong;
said device cells hold system configuration information that is constituted of lists of CPU cells that correspond to said system identifiers;
said device cells select any one CPU cell from among groups to which the CPU cells belong based on said system configuration information that is held and said system identifiers that are transmitted from said CPU cells together with said commands, and transmit response messages that contain processing results for the commands to the selected CPU cells; and
CPU cells, upon receiving said response messages from said device cells, acquire processing results of said device cells in accordance with the response messages.

8. A device sharing method for sharing devices in a multiprocessor system that includes a plurality of CPU cells that are each provided with at least one CPU, said CPU cells being divided into a plurality of groups, each of these groups operating under a different operating system; said method comprising the steps of:
storing a device control information for controlling a plurality of types of processing that can be executed by devices, to device cells that include said devices and that are connected to said CPU cells by way of a network;
in said device cells, upon receiving commands from said CPU cells, searching a device control information that corresponds to the originators of the commands; and
in said device, executing a processing that is designated by said device control information that has been updated by said commands.

9. The device sharing method according to claim 8, wherein said device control information is provided to correspond to each of said plurality of CPU cells.

10. The device sharing method according to claim 8, wherein said device control information is provided in any number of sets that does not match the number of said groups or the number of said CPU cells.

11. The device sharing method according to claim 8, wherein: said CPU cells hold, in a table format, information on said devices that said CPU cells can use; and
each of said CPU cells preferentially uses devices that are assigned to that CPU cell at the time of system start-up.

12. The device sharing method according to claim 8, wherein:
said device cells are provided with a plurality of similar devices; and
said device cells cause any device among said plurality of devices to execute processing that is designated by said device control information.

13. The device sharing method according to claim 8, wherein:
said CPU cells are each provided with a command transmission circuit for generating commands in which are combined a plurality of instructions that are issued from said CPUs;
said device cells are each provided with a command analysis unit for parsing said commands and extracting a plurality of instructions; and
said devices are caused to execute processes that are designated by said device control information that has been updated by the plurality of extracted instructions.

14. The device sharing method according to claim 8, wherein:
said CPU cells hold system identifiers for specifying said groups to which said CPU cells belong;
said device cells hold system configuration information that is constituted from lists of CPU cells that correspond to said system identifiers;
said device cells select any one of said CPU cells from among the group to which the CPU cells belong based on said system identifiers that are transmitted together with said commands from said CPU cells and said system configuration information that is held, and transmit response messages to the selected CPU cells that contain processing results in response to said commands;
said CPU cells, upon receiving said response messages from said device cells, acquire the processing results of said device cells in accordance with the response messages.
